(19) United States
(12) Patent Application Publication
(10) Pub. No.: US 2026/0259405 A1
(43) Pub. Date: Sep. 3, 2026

(54) DISPLAY SYSTEM FOR VEHICLE AND ASSOCIATED VEHICLE

(71) Applicant: Faurecia Clarion Electronics Europe, Paris (FR)

(72) Inventors: Stéphane DA CRUZ, JOUY-SOUS-THELLE (FR); Steve LIEM, ERAGNY SUR OISE (FR); Mickaël LE CORRE, SAINT MAUR DES FOSSES (FR)

(21) Appl. No.: 19/554,519

(22) Filed: Mar. 2, 2026

(30) Foreign Application Priority Data
Feb. 28, 2025 (FR) FR 2502055

(51) Int. Cl. G02B 27/00; B60K 35/22

(52) U.S. Cl. CPC G02B 27/0018; B60K 35/22; B60K 2360/25

(57) ABSTRACT

The present invention relates to a display system comprising a protective lens forming a display surface, an apparatus emitting a plurality of incident light beams into a vehicle, intended for a user of the vehicle, the display system further comprising an optical filter film arranged between the apparatus and the protective lens,
said apparatus having a normal axis, orthogonal to the display surface, and an elevation axis directed from bottom to top of the apparatus, said normal axis and said elevation axis forming a plane of visibility,
the optical filter film being configured to prevent light rays incident on the optical filter film, and forming an angle of incidence greater than a predetermined filter angle with respect to the normal axis in the plane of visibility, from exiting the display system.

### TECHNICAL FIELD OF THE INVENTION

The present invention relates to a display system for a vehicle, and an associated vehicle.

The invention relates to the field of display systems more particularly suitable for integration in transport vehicles, notably motor vehicles.

### BACKGROUND OF THE INVENTION

It is known that modern motor vehicles are equipped with a plurality of light-emitting devices, such as for example display screens, suitable for displaying various driving-related information and/or multimedia infotainment content. These display screens thus help the driver to steer the vehicle and enhance the comfort of the driver and passengers of the vehicle during the journey.

Naturally, these apparatuses emit light rays in order to perform these functions.

However, these light rays can be reflected off the windscreen of the vehicle and notably distract the driver during driving, particularly when driving at night.

A first existing solution to this problem is the use of a trim, installed above the apparatus, to block the light rays emitted by the apparatus towards the windscreen. Nevertheless, this solution takes up space in the passenger compartment of the vehicle, whilst being unsightly.

A second existing solution consists of tilting the display apparatus at a certain angle, or moving the display apparatus further away or closer to the driver's seat when assembling the passenger compartment of the vehicle, in order to avoid this light reflection on the windscreen. However, this tilting or this increase/decrease in distance can make the information displayed on the apparatus less visible, and imposes an additional constraint on the manufacturer when designing the vehicle.

There is therefore a need to offer a display system that avoids the reflection of light rays emitted by a display apparatus on the vehicle windscreen, while maintaining unchanged brightness of the display apparatus, aimed at safer driving of the vehicle.

The aim of the invention is to provide a display system that meets the above requirements.

### SUMMARY OF THE INVENTION

To this end, the object of the invention is a display system comprising a protective lens forming a display surface, an apparatus emitting a plurality of incident light rays into a vehicle, the apparatus being configured to display at least one piece of information to a user of the vehicle, the display system further comprising an optical filter film arranged between the apparatus and the protective lens,
said apparatus having a normal axis, orthogonal to the display surface, and an elevation axis directed from bottom to top of the apparatus, said normal axis and said elevation axis forming a plane of visibility,
said optical filter film being configured to prevent light rays incident on the optical filter film and forming an angle of incidence greater than a predetermined filter angle with respect to the normal axis in the plane of visibility from exiting the display system.

By virtue of the proposed arrangement, the incident light rays emitted by the apparatus are perfectly visible to the user, and the optical filter film filters out incident light rays likely to be reflected by the vehicle windscreen.

According to other advantageous aspects of the invention, the display system comprises one or more of the following features, taken alone or in any technically feasible combination:
the apparatus is a vehicle display screen;
the display system comprises two layers of optically transparent adhesive, each layer having a predefined thickness, the first layer being suitable for assembling the optical filter film and the protective lens, and the second layer being suitable for assembling the vehicle display screen and the optical filter film;
the apparatus comprises at least one indicator light configured to emit a plurality of incident light rays;
the display system comprises a layer of optically transparent adhesive suitable for assembling the optical filter film and the protective lens;
the display surface forms a predefined angle with a plane formed by the vehicle display screen, the predefined angle being configured based on an angle of inclination between an axis along a windscreen of the vehicle and a horizontal axis of the vehicle;
the predetermined filter angle is between 30° and 60°;
the display system comprises a decorative layer arranged between the apparatus and the optical filter film, said decorative layer being visible to the user when the apparatus is switched off, and invisible to the user when the apparatus is switched on; and
the optical filter film is a thin flexible film with a thickness of between 100 and 200 micrometers.

The invention also relates to a receptacle comprising such a display system.

### BRIEF DESCRIPTION OF THE DRAWINGS

The invention will become clearer on reading the following description, given solely by way of non-limiting example, and made with reference to the drawings, wherein:

FIG. 1 is a schematic view of a vehicle comprising a display system according to the invention;

FIG. 2 is a cross-sectional view of a display system according to a first embodiment of the invention;

FIG. 3 is a front view of a display apparatus fitted with a display device; and

FIG. 4 is a cross-sectional view of a display system according to a second embodiment of the invention.

### DETAILED DESCRIPTION OF SOME EMBODIMENTS

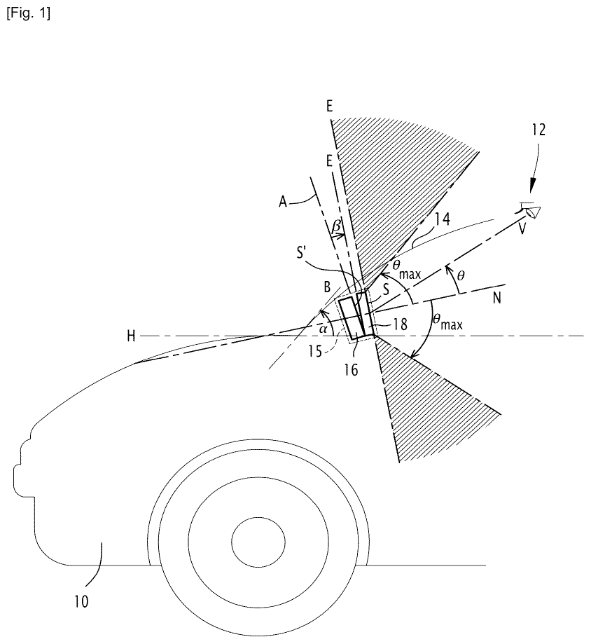

FIG. 1 schematically shows, in profile, a portion of a vehicle 10, comprising a horizontal axis H parallel to the ground.

The vehicle 10 is preferentially a motor vehicle, such as for example a car, a truck or a bus.

FIG. 1 also shows a user 12 of the vehicle 10, with the user 12 represented by one of their eyes, looking along viewing axis V.

The user 12 is, for example, a driver of the vehicle 10, or a front passenger of the vehicle 10.

The vehicle 10 is equipped with a windscreen 14, facing the user 12. The windscreen 14 follows an axis of the windscreen B, intersecting with the horizontal axis H and thus forming an angle of inclination α, as shown in FIG. 1.

The vehicle 10 comprises a display system 15 comprising a display apparatus 16 emitting a plurality of incident light beams, and configured to display at least one piece of information to the user 12.

According to a first embodiment of the invention, the apparatus 16 is a display screen of the vehicle 10.

The display screen is, for example, a liquid crystal display (LCD), in particular of the TFT-LCD type.

The display screen then forms a surface of the apparatus S′, and extends vertically along an axis A of the apparatus.

For example, the apparatus 16 is a display screen located on a dashboard of the vehicle 10.

The display system 15 further comprises a display device 18.

The display device 18 is positioned on the apparatus 16, so as to cover the entire surface of the apparatus S′.

Preferentially, according to this first embodiment of the invention, the display device 18 has a geometry similar to that of the apparatus 16.

For example, the apparatus 16 is a display screen having a parallelepiped shape, and the display device 18 thus also has a parallelepiped shape.

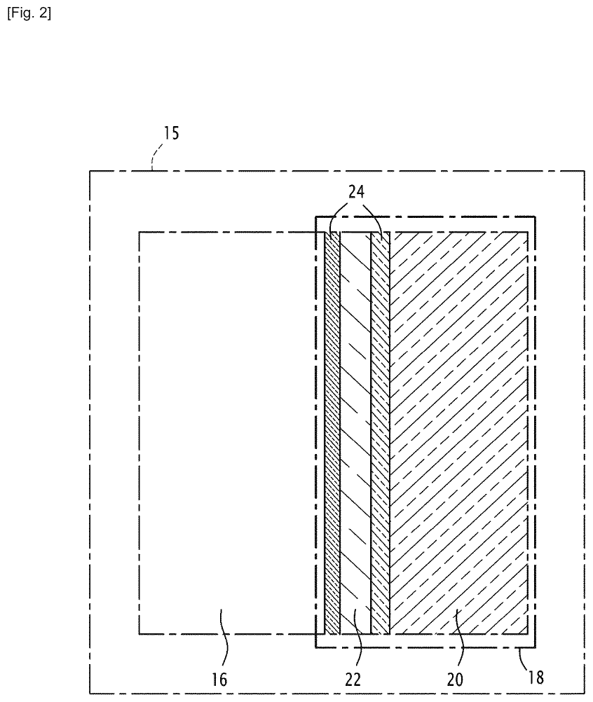

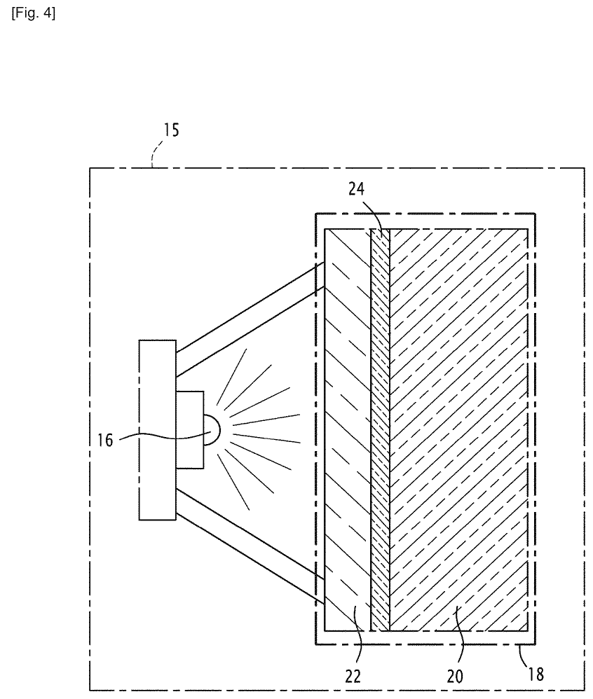

The display system 15, embodiments of which are shown in FIGS. 2 and 4, comprises a protective lens 20 and an optical filter film 22.

A first embodiment is shown in FIG. 2.

The protective lens 20 is adapted to protect the apparatus 16 from potential external damage, such as scratches or impacts.

The protective lens 20 has a predefined thickness, advantageously between 1 and 2.5 millimeters.

The optical filter film 22 forms a light guide with an associated predetermined filter angle. For example, the optical filter film 22 is produced using a bonding method (such as lamination).

Preferably, the optical filter film 22 is a flexible thin film with a thickness of between 100 and 200 μm. By way of example, the thin film is a transparent plastic film, for example made of optical-grade polycarbonate (PC) or polymethyl methacrylate (PMMA).

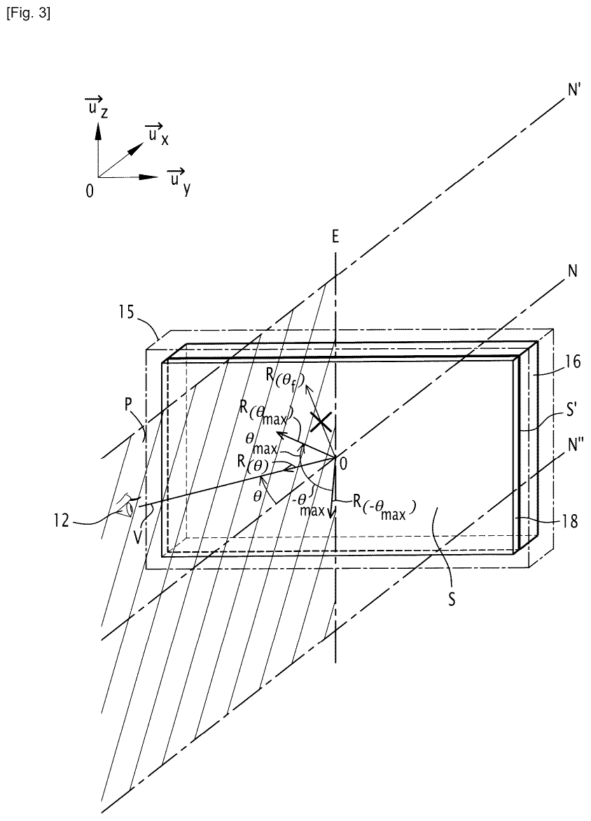

A first arrangement of the elements of the display system 15 is disclosed referring to FIG. 3.

In order to clarify this first arrangement of the various elements forming the display system 15, a reference frame (O; \vec{uₓ}; \vec{u_{y}}; \vec{u_{z}}) is shown in FIG. 3, wherein O is the center of the display system 15, and \vec{uₓ}, \vec{u_{y}}, \vec{u_{z}} are three directional vectors in each of the three dimensions of the space shown.

Without loss of generality, it is assumed that O is a point of incidence of a plurality of incident light rays R(θ), R(θₘₐₓ), R(θ_{f}) , R(−θₘₐₓ) emitted by the apparatus 16. It is also assumed that point O is viewed by the user 12, and that the viewing axis V thus passes through O.

The protective lens 20 forms a display surface S, in the plane (O; \vec{u_{y}}; \vec{u_{z}}) and extends vertically along an elevation axis E, parallel to the axis (O; \vec{u_{z}}), coinciding with the axis A of the apparatus. According to this first arrangement, the angle β shown in FIG. 1 is therefore zero.

The protective lens 20 further comprises a normal axis N=(O; \vec{uₓ}) orthogonal to the display surface S.

Furthermore, the normal axis N and the elevation axis E form a plane of visibility P=(O; \vec{uₓ}; \vec{u_{z}}) comprising the viewing axis V and the incident light rays R(θ), R(θₘₐₓ), R(θ_{f}) , R(−θₘₐₓ), as shown in FIG. 3.

In order to clarify the drawing of the plane of visibility P in FIG. 3, two axes N′ and N″ are defined, both parallel to the normal axis N, respectively translated in directions \vec{u_{z}} and −\vec{u_{z}}.

The optical filter film 22 is positioned between the protective lens 20 and the apparatus 16, as shown in FIG. 2.

Advantageously, the protective lens 20 and the optical filter film 22 are bonded by a first layer of optically transparent adhesive 24, and the optical filter film 22 and the apparatus 16 are bonded by a second layer of optically transparent adhesive 24.

Even more advantageously, each layer of optically transparent adhesive has a predefined thickness of between 25 and 75 micrometers.

In this way, the optical filter film 22 also extends along the elevation axis E.

Additionally, and referring to FIG. 3, the optical filter film 22 is suitable for filtering incident light rays R(θ) emitted by the apparatus 16 forming an angle of incidence θ greater than the predetermined filter angle, hereinafter referred to as θₘₐₓ, with respect to the normal axis N in the plane of visibility P.

“Filtering incident light rays” is understood to mean preventing light rays incident R(θ) on the optical filter film 22 forming an angle of incidence θ greater than θₘₐₓ or less than −θₘₐₓ with respect to the normal axis N in the plane of visibility P, from exiting the display system 15.

According to this operation, the incident rays R(θ) and, as a result, the at least one piece of information displayed by the apparatus 16, are visible to the user 12 if |θ|≤θₘₐₓ, and invisible to the user 12 if |θ|>θₘₐₓ.

Furthermore, the predetermined filter angle θₘₐₓ is preferentially selected so that the incident rays R(θ) cannot be reflected on the windscreen 14 of the vehicle 10 if |θ|>θₘₐₓ.

Advantageously, the predetermined filter angle θₘₐₓ is between 30° and 60°.

Therefore, referring to the example in FIG. 3, among the incident light rays R(θ), R(θₘₐₓ), R(θf) , R(−θₘₐₓ) emitted by the apparatus 16, only the incident light rays R(θ), R(θₘₐₓ), R(−θₘₐₓ) are visible to the user 12, the ray R(θ_{f}) being filtered by the optical filter film 22.

Thus, advantageously, none of the incident rays R(θ), R(θₘₐₓ), R(θ_{f}) , R(−θₘₐₓ) emitted by the apparatus 16 at the point of incidence O can be reflected on the windscreen 14 of the vehicle 10.

According to an alternative arrangement, the display device 18 is installed on the apparatus 16 such that the elevation axis E of the protective lens 20 forms a predefined angle β strictly positive with the apparatus axis A, as shown in FIG. 1.

According to this alternative, the predefined angle β is selected when the display device 18 is assembled on the apparatus 16, based on the angle of inclination α.

In particular, the display device 18 is assembled on the apparatus 16 based on the model of the vehicle 10.

For example, the vehicle 10 is a sports car, generally having an angle of inclination α between 30° and 50°. The predefined angle β is of the order of ten degrees.

According to another example, the vehicle 10 is a pickup truck, generally having an angle of inclination α between 60° and 80°. The predefined angle β selected is then of a few degrees.

A second embodiment of the display system 15 is described below referring to FIG. 4.

According to this second embodiment of the invention, the apparatus 16 comprises at least one indicator light emitting a plurality of incident light rays.

The indicator light is, for example, an LED or a plurality of LEDs.

The display device 18 is then positioned so as to cover the entire surface of the at least one indicator light of the apparatus 16, in order to filter the incident rays emitted by the apparatus 16 that can be reflected on the windscreen 14 of the vehicle 10.

The display device 18 is further positioned at a predefined distance from the at least one indicator light of the apparatus 16, the predefined distance being selected based on several parameters intrinsic to the apparatus 16.

For example, the display device 18 is positioned at a predefined short distance from the apparatus 16 when the apparatus 16 emits light rays of high luminous intensity, and the display device 18 is positioned at a predefined longer distance if the apparatus 16 emits light rays of low luminous intensity.

According to this second embodiment of the invention, the display device 18 comprises a protective lens 20 and an optical filter film 22, bonded by a single layer of optically transparent adhesive 24, as shown in FIG. 4.

In addition, the optically transparent adhesive layer 24 comprises a predefined thickness of between 25 and 75 micrometers.

As an optional extra, the display device 18 according to any one of the embodiments of the invention also comprises a decorative layer arranged between the apparatus 16 and the optical filter film 22.

The decorative layer is suitable for displaying a set of decorative patterns when the apparatus 16 is switched off. When the apparatus 16 is switched on, the decorative layer is adapted to be invisible to the user 12.

Independently of the addition of the decorative layer disclosed hereinbefore, the display system 15, via the optical filter film 22, retains its properties of filtering the incident light rays emitted by the apparatus 16, depending on the angle of incidence of the incident light rays, as described in the previous arrangements.

In short, the display system 15 comprising the display device 18 according to the embodiments described hereinbefore ensures that all the incident rays emitted by the apparatus 16 cannot be reflected on the windscreen 14 of the vehicle 10, without having to implement an additional system imposing severe spatial and/or technical constraints when designing the passenger compartment of the vehicle 10.

Furthermore, the display device 18 enables this function to be implemented without reducing the luminous intensity of the light beams emitted by the apparatus 16. Indeed, the incident rays having an angle of incidence θ between −θₘₐₓ and θₘₐₓ are not attenuated or filtered by the optical filter film 22. The user 12 therefore sees no difference between a display screen equipped with such a display device 18 and a display screen on its own.

1. A display system comprising a protective lens forming a display surface, an apparatus emitting a plurality of incident light rays into a vehicle, the apparatus being configured to display at least one piece of information to a user of the vehicle, the display system further comprising an optical filter film arranged between the apparatus and the protective lens,
said apparatus having a normal axis, orthogonal to the display surface, and an elevation axis directed from bottom to top of the apparatus, said normal axis and said elevation axis forming a plane of visibility,
wherein the optical filter film is configured to prevent light rays incident on the optical filter film and forming an angle of incidence greater than a predetermined filter angle with respect to the normal axis in the plane of visibility from exiting the display system.

2. The display system according to claim 1, wherein the apparatus is a vehicle display screen.

3. The display system according to claim 2, further comprising two layers of optically transparent adhesive, each layer having a predefined thickness, the first layer being suitable for assembling the optical filter film and the protective lens, and the second layer being suitable for assembling the vehicle display screen and the optical filter film.

4. The display system according to claim 1, wherein the apparatus comprises at least one indicator light configured to emit a plurality of incident light rays.

5. The display system according to claim 4, further comprising a layer of optically transparent adhesive suitable for assembling the optical filter film and the protective lens.

6. The display system according to claim 2, wherein the display surface forms a predefined angle with a plane formed by the vehicle display screen, the predefined angle being configured based on an angle of inclination between an axis along a windscreen of the vehicle and a horizontal axis of the vehicle.

7. The display system according to claim 1, wherein the predetermined filter angle is between 30° and 60°.

8. The display system according to claim 1, further comprising a decorative layer arranged between the apparatus and the optical filter film, said decorative layer being suitable for being visible to the user when the apparatus is switched off, and invisible to the user when the apparatus is switched on.

9. The display system according to claim 1, wherein said optical filter film is a flexible thin film, with a thickness of between 100 and 200 micrometers.

10. A vehicle comprising a display system according to claim 1.
